(19) United States
(12) Patent Application Publication
(10) Pub. No.: US 2015/0276455 A1
(43) Pub. Date: Oct. 1, 2015

(54) MEASUREMENT ARRANGEMENT AND DISHWASHER CONTAINING A MEASUREMENT ARRANGEMENT

(71) Applicant: ELECTROLUX HOME PRODUCTS CORPORATION N.V., BRUSSELS (BE)

(72) Inventors: Simon Trbojevic, Stockholm (SE); Maciej Zienkiewicz, Jaefaella (SE)

(73) Assignee: ELECTROLUX HOME PRODUCTS CORPORATION N.V., BRUSSELS (BE)

(21) Appl. No.: 14/246,325

(22) Filed: Apr. 7, 2014

(30) Foreign Application Priority Data
Mar. 28, 2014 (DE) 202014101476.4

(51) Int. Cl. G01F 23/14; A47L 15/00

(52) U.S. Cl. CPC G01F 23/14; A47L 15/0023

(57) ABSTRACT

A measurement arrangement for determining the liquid level in a dishwasher and a dishwasher including the measurement arrangement are provided. In one embodiment, the measurement arrangement comprises a housing having a liquid pump which is connected, at the intake end, to a pump sump which is formed in the housing and comprises a liquid space, having a liquid inlet which is provided on the housing and by means of which liquid from a dishwashing space in the dishwasher flows into the pump sump, having a liquid outlet which is formed in the housing and is connected to the delivery end of the liquid pump, wherein a sensor unit is provided for measuring the liquid level, said sensor unit being connected to the liquid space in the pump sump and being designed to measure the hydrostatic pressure which is created by the liquid level in the pump sump.

### CROSS-REFERENCE TO RELATED APPLICATIONS

This Application claims priority to German Utility Model Application 202014101476.4, filed on Mar. 28, 2014, which is hereby incorporated herein in its entirety by reference.

### BACKGROUND

The invention relates, in principle, to a measurement arrangement.

In particular, the invention relates to a measurement arrangement for measuring the liquid level in dishwashers.

Measurement arrangements for measuring the liquid level in dishwashers are already known. Measurement arrangements of this kind are used to control the supply of water to the dishwasher in order that the dishwasher is operated with a desired quantity of dishwashing liquid which, in addition to dishwashing additives, substantially comprises water.

DE 20 2006 004 757 U1 discloses, for example, an electrical sensor apparatus for controlling the level of cleaning water in a dishwasher. The sensor apparatus substantially comprises air-pressure threshold value sensors which are connected to the cleaning chamber or to the pan of the dishwasher by means of pipes which are in the form of hoses.

A significant disadvantage of this sensor apparatus is that the sensor apparatus comprises a large number of components which have to be arranged within the dishwasher and therefore take up a large amount of installation space. A further disadvantage is that leaks can be produced on account of the large number of connecting points, it being possible for the said leaks to lead to corruption of the measurement result or to dishwashing liquid escaping.

### SUMMARY

Proceeding from the above, the object of the invention is to specify a measurement arrangement which provides a substantially simplified structure together with a low installation space requirement and increased operational reliability. The object is achieved by the features of independent claim 1. Preferred exemplary embodiments are described in the dependent claims. Unless otherwise stated, the exemplary embodiments of the invention can be combined with one another in any desired manner.

According to a first aspect, the invention relates to a measurement arrangement for determining the liquid level in a dishwasher. The measurement arrangement comprises a housing having a liquid pump which is connected, at the intake end, to a pump sump which is formed in the housing and comprises a liquid space. The housing furthermore has a liquid inlet by means of which liquid from a dishwashing space in the dishwasher flows into the pump sump. The housing further has a liquid outlet which is connected to the delivery end of the liquid pump. In addition, a sensor unit is provided on the measurement arrangement for measuring the liquid level, the said sensor unit being connected to the liquid space in the pump sump preferably directly or by means of a coupling piece. In this case, the sensor unit is designed to measure the hydrostatic pressure which is created by the liquid level in the pump sump. In particular, the sensor unit is arranged directly on the housing in the region of the pump sump in such a way that it is possible to measure the liquid level without providing an air barrier layer or an air pocket between the sensor unit and the pump sump. As a result, a measurement arrangement with a simple structure, a low installation space requirement and a high level of operational reliability is achieved.

According to one aspect of the invention, the sensor unit is designed to measure the pressure of liquids and gases, in particular air. As a result, the fluid level in the pump sump can also be determined in a highly accurate manner when there is air or an air pocket in the measurement space in the sensor unit.

According to one exemplary embodiment of the invention, the sensor unit is arranged on the pump sump directly or by means of a coupling piece. If a coupling piece is used, said coupling piece preferably has a fluid channel with a short length, for example a length of less than 5 cm, preferably less than 3 cm. In this case, the coupling piece serves only to couple the sensor unit to the housing in a fluid-tight manner, so that the dishwashing liquid is conducted from the pump sump into the sensor unit.

According to a further exemplary embodiment of the invention, the sensor unit is arranged on the pump sump in such a way that liquid, in particular the dishwashing liquid from the pump sump, enters a measurement space in the sensor unit. In this case, the sensor unit is arranged, in particular, in such a way that, during operation of the dishwasher and in the process with the pump sump at least partially filled, dishwashing liquid with a liquid level which is dependent on the filling level in the pump sump is accommodated in the measurement space, so that the filling level can be measured by the sensor unit. As an alternative, air is contained in the measurement space in the sensor unit, wherein the liquid in the pump sump exerts a pressure on the air which is contained in the measurement space in the sensor unit, so that this pressure can be used as a measurement variable in the sensor unit. In any event, the sensor unit or the coupling piece of the sensor unit is connected directly to the liquid space in the pump sump, that is to say without interposed gas barriers which prevent liquid from entering the sensor unit.

According to a further exemplary embodiment of the invention, the sensor unit has a diaphragm which at least partially delimits a measurement space and which can be deformed by the hydrostatic pressure of the liquid. The diaphragm is formed, for example, from a flexible material, for example rubber, silicone et cetera. Said diaphragm is either reversibly deformable itself or the sensor unit has means for reversibly deforming the diaphragm. Depending on the filling level of the dishwashing liquid in the pump sump, a filling level-dependent pressure is exerted on the diaphragm and, in the process, the diaphragm is at least partially deflected, in particular in the central part of the diaphragm. In other words, the degree of the deflection of the diaphragm is a measure of the filling level in the pump sump.

According to a further exemplary embodiment of the invention, a magnet, in particular a permanent magnet, is provided on that side of the diaphragm which is averted from the measurement space. The magnet is preferably provided at the point of the diaphragm at which the diaphragm is deflected to the maximum extent. In the case of a diaphragm which is fixed in the edge region, said point is, in particular, the central region of the diaphragm.

According to a further exemplary embodiment of the invention, the sensor unit is designed to determine the filling level based on the distance of the magnet from a measurement electronics system. Owing to the filling level-dependent deflection of the diaphragm, the magnet which is provided on this diaphragm is likewise deflected in a filling level-dependent manner and, in the process, its distance from the measurement electronics system changes. This measurement electronics system is designed to receive the magnetic field which is generated by the magnet, wherein the magnetic field which is received at the measurement electronics system changes as a function of the distance of the magnet. Therefore, the distance of the magnet or the magnetic field which is received in a distance-dependent manner can be used to determine the liquid level in the pump sump.

According to a further exemplary embodiment of the invention, an intermediate layer is provided beneath the diaphragm, the said intermediate layer delimiting a space beneath the diaphragm from the measurement electronics system. In other words, a further space is provided beneath the diaphragm, the said space being delimited on a first side by the diaphragm itself and on a further side by the intermediate layer. In particular, the intermediate layer can be provided continuously across the entire housing cross section of the sensor unit. This intermediate layer has the effect that the measurement electronics system, in addition to the separation effect of the diaphragm, is additionally or redundantly protected by the intermediate layer against the ingress of liquid, in particular dishwashing liquid from the measurement space, specifically in particular when the diaphragm has a leak.

According to a further exemplary embodiment of the invention, the intermediate layer has at least two layers of an electrically insulating material. This has the effect that the sensor unit complies with electrical protection class II and therefore provides a high degree of operational reliability.

In a preferred exemplary embodiment, a measurement electronics system with a sensor element which interacts with the magnet is situated opposite the magnet. In this case, the sensor element can be designed, in particular, to interact with the magnet in such a way that electrical properties of the sensor element change as a function of the distance of the magnet from the sensor element or as a function of the strength of the magnetic field. Owing to this change in the electrical properties, an electrical measurement signal can be generated as a function of the distance of the magnet from the sensor element, the said measurement signal being dependent on the liquid level in the pump sump. The sensor element can have, for example, a magnetoresistive element, the electrical resistance of the said magnetoresistive element changing as a function of the position of the magnet or of the field strength of the magnetic field. As an alternative, the sensor element can have at least one electrical resonant circuit, the resonant frequency of the said resonant circuit changing as a function of the position of the magnet or of the field strength of the magnetic field.

The invention furthermore relates to a dishwasher which comprises a measurement arrangement which is designed according to the above-described exemplary embodiments.

Within the meaning of the invention, the expression “substantially”, “for example” or “approximately” means deviations from the respectively exact value by +/−10%, preferably by +/−5% and/or deviations in the form of changes which are insignificant in respect of functioning.

### BRIEF DESCRIPTION OF THE DRAWINGS

The invention will be explained in greater detail below using an exemplary embodiment with reference to the figures, in which:

FIG. 1 shows, by way of example, a perspective side view of a measurement arrangement according to the invention;

FIG. 2 shows, by way of example, a perspective plan view of a sensor unit of the measurement arrangement according to the invention with a coupling piece; and

FIG. 3 shows, by way of example, a longitudinal section through a sensor unit of the measurement arrangement according to the invention with a coupling piece.

### DETAILED DESCRIPTION OF PREFERRED EMBODIMENTS

The invention will be described below with reference to the above-described figures in which exemplary embodiments are shown by way of example. However, the invention is in no way limited to the described exemplary embodiments. Identical reference signs are used for identifying identical elements, parts, sections or features in the following description as far as possible.

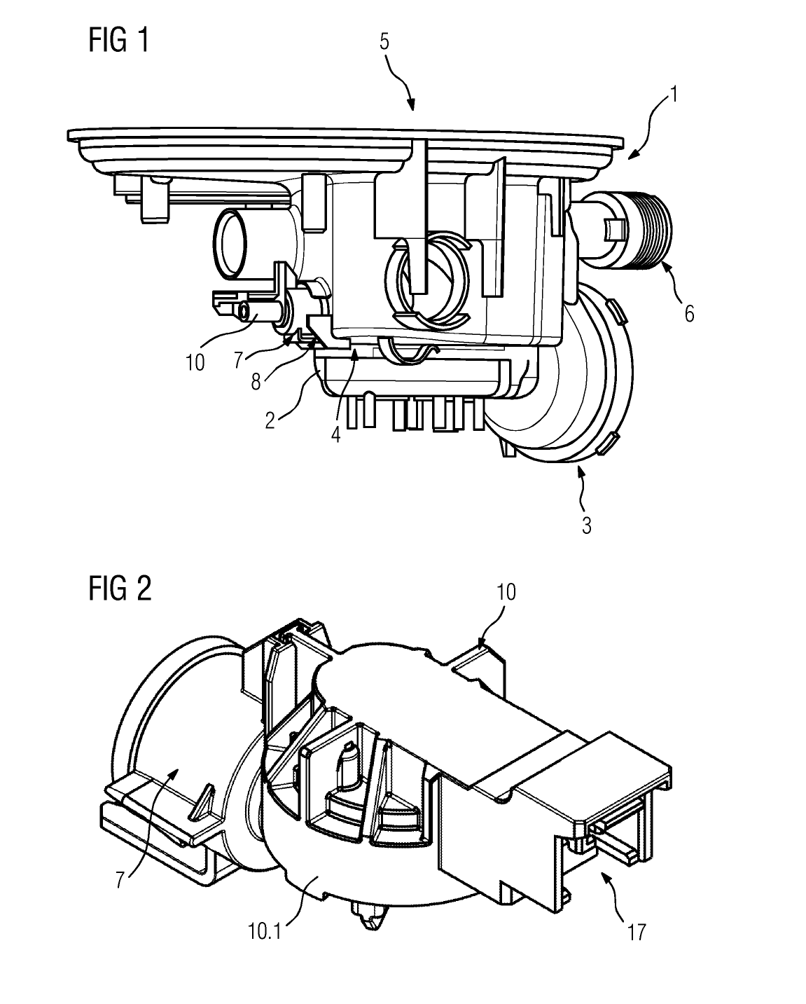

FIG. 1 shows an exemplary embodiment of a measurement arrangement 1 according to the invention. The measurement arrangement 1 is provided for determining the liquid level in a dishwasher. Said measurement arrangement comprises a housing 2 which is, for example, in the form of a funnel or substantially in the form of a funnel and which has a pump sump 4 provided in its interior, the said pump sump forming a liquid space for accommodating the dishwashing liquid. As dishes are being washed in the dishwasher, the dishwashing liquid passes by means of a liquid inlet 5, which is provided at the top end of the housing 2, into the liquid space of the pump sump 4 due to the force of gravity. Furthermore, a liquid pump 3 is provided in or on the housing 2, the said liquid pump being connected, at the intake end, to the liquid space in the pump sump 4. This liquid pump 3 draws the dishwashing liquid away from the liquid space in the pump sump 4 by suction and conveys the said dishwashing liquid away by means of a liquid outlet 6 which is connected to the delivery end of the liquid pump 3, so that the dishwashing liquid can once again be used for the dishwashing process.

The measurement arrangement 1 further has a sensor unit 10 which is designed to measure the liquid level in the pump sump 4. In this case, the sensor unit 10 is connected to the liquid space in the pump sump 4, wherein this connection is, in particular, a fluid connection. In particular, the housing 2 has a lateral opening or a connection point 8 in the region of the pump sump 4, it being possible to couple the sensor unit 10 to the said connection point. In this case, the sensor unit 10 is designed to measure the hydrostatic pressure which is created by the liquid level in the pump sump 4, that is to say the pressure due to the force of gravity which is established on the sensor unit 10 on account of the level-dependent liquid column in the pump sump. Therefore, the sensor unit 10 is designed to directly measure the hydrostatic pressure which is created by the liquid level without providing an air gap or air cushion which causes separation.

As can be seen in FIG. 1, the connection point 8 is arranged in the lower region of the pump sump 4, so that liquid enters a measurement space in the sensor unit 10 in order to determine the liquid level in the pump sump 4. The sensor unit 10 is preferably designed to measure the pressure of liquids and gases, in particular of air, so that it is possible to measure the liquid level in the pump sump 4 even when the measurement space in the sensor unit 10 at least partially contains gas or air. In this case, the sensor unit 10 can either be arranged directly on the housing 2 in the region of the pump sump 4 or be connected to the housing 2 by means of a coupling piece 7.

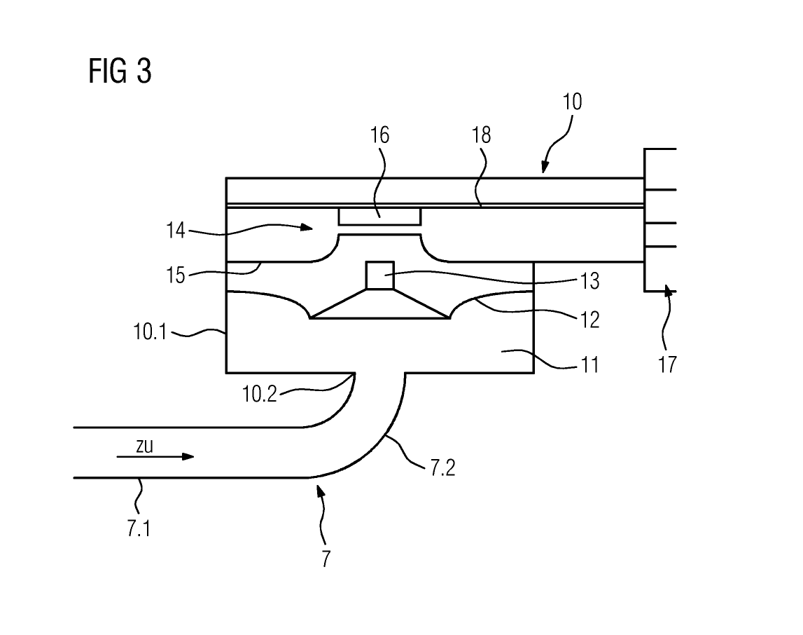

FIGS. 2 and 3 each show, in a highly detailed manner, the sensor unit 10 with the coupling piece 7 arranged on it. The sensor unit 10 has a housing 10.1 in which the measurement space 11 for measuring the hydrostatic pressure and also the measurement electronics system 14 which is required for this measurement are provided. A coupling region 17 for an electrical plug connection is further provided on the housing 10.1, so that the sensor unit 10 can be connected to a control unit (not illustrated). A connection region 10.2 is preferably provided at the top end of the housing 10.1, it being possible for the coupling piece 7 to be connected to the said connection region in order to connect the sensor unit 10 to the housing 2. The coupling piece 7 is preferably designed as an angular piece and has, in particular, a first coupling piece region 7.1 which runs horizontally in the installed state, and a second coupling piece region 7.2 which runs vertically in the installed state. The coupling piece 7 can be connected to the housing 2 by way of the free end of the first coupling piece region 7.1. The free end of the second coupling piece region 7.2 serves to connect the coupling piece 7 to the sensor unit 10.

As can be seen, in particular, with reference to the sectional illustration according to FIG. 3, the dishwashing liquid can flow into the measurement space 11 by means of the coupling piece 7, as indicated by the arrow “in”. A diaphragm 12 which closes off the measurement space 11 at the top in a fluid-tight manner is provided in the measurement space 11. When the sensor unit 10 is arranged on the housing 2, a liquid level which is reached in the measurement space 11 in the process reaches the diaphragm 12 and deforms the diaphragm 12 in a reversible manner as a function of the liquid level in the pump sump 4. In particular, the diaphragm 12 has a central region, the vertical position of the said central region changing as a function of the liquid level in the pump sump 4. In particular, this central region of the diaphragm 12 will move upward as the liquid level increases. A magnet 13 is provided on the diaphragm 12, in particular in the central region of the diaphragm 12, the said magnet being fixedly connected to the diaphragm 12. The magnet 13 is preferably formed by a permanent magnet. The position of the magnet 13 in the vertical direction changes as the diaphragm 12 deforms.

Furthermore, the measurement electronics system 14 is provided in the housing 10.1 of the sensor unit 10, the said measurement electronics system interacting with the magnet 13 in such a way that a change in position of the magnet 13 in relation to the measurement electronics system 14 is detected and converted into a measurement signal. As a result, a change in the liquid valve in the pump sump 4 is converted into an electrical measurement signal. In this case, the measurement electronics system 14 can have, in particular, a sensor element 16 by means of which the magnetic field which is produced by the magnet 13 is detected and converted into an electrical signal. In this case, the sensor element 16 can contain, in particular, a magnetoresistive element, the electrical resistance of the said magnetoresistive element changing as a function of the prevailing magnetic field and therefore as a function of the position of the magnet 13. As an alternative, the sensor element 16 can comprise an electrical resonant circuit, the resonant frequency of the said resonant circuit changing as a function of the prevailing magnetic field and therefore as a function of the position of the magnet 13. The sensor element 16 can be mounted, for example, on a support 18 by means of which an electrical connection to the electrical connections which are provided in the coupling region 17 is established. In this case, the support 18 can be, in particular, a printed circuit on which the sensor element 16 is arranged.

As shown in FIG. 3 in particular, the sensor element 16 is arranged at a distance from and above the magnet 13 in the vertical direction, so that this magnet 13 can execute a vertical reciprocating movement. An intermediate layer 15 is preferably provided between the diaphragm 12 and the measurement electronics system 14 in the vertical direction. The intermediate layer 15 serves as a further fluid-tight separation from the measurement electronics system 14, specifically in particular when the diaphragm 12 has a leak, so that fluid which is contained in the measurement space 11 can pass through the diaphragm 12 in the direction of the measurement electronics system 14. This has the result that no electrical short-circuits are produced in the region of the measurement electronics system 14.

In this case, the intermediate layer 15 preferably runs over the entire area of the housing 10.1 between the diaphragm 12 and the measurement electronics system 14. The said intermediate layer preferably has a plurality of layers in order to achieve an improved blocking effect as a result. In this case, the intermediate layer can be matched, in particular, to the shape of the diaphragm 12 in the no-load state and/or be shaped in the region between the magnet 13 and the sensor element 16 in such a way that a movement space is created for the change in position of the magnet 13 during the filling level measurement process.

This document has described exemplary embodiments of a measurement arrangement according to the present invention as granted protection in the appended claims. These exemplary embodiments should be understood to be merely non-limiting examples. As has long been known to a person skilled in the art, numerous amendments and modifications are possible, without departing from the concept on which the invention is based in the process.

### LIST OF REFERENCE SYMBOLS

1 Measurement arrangement

2 Housing

3 Liquid pump

4 Pump sump

5 Liquid inlet

6 Liquid outlet

7 Coupling piece

7.1 First coupling piece region

7.2 Second coupling piece region

8 Connection point

10 Sensor unit

10.1 Housing

10.2 Connection region

11 Measurement space

12 Diaphragm

13 Magnet

14 Measurement electronics system

15 Intermediate layer

16 Sensor element

17 Coupling region

18 Support

1. Measurement arrangement for determining the liquid level in a dishwasher, comprising a housing having a liquid pump which is connected, at the intake end, to a pump sump which is formed in the housing and comprises a liquid space, having a liquid inlet which is provided on the housing and by means of which liquid from a dishwashing space in the dishwasher flows into the pump sump, having a liquid outlet which is formed in the housing and is connected to the delivery end of the liquid pump, wherein a sensor unit is provided for measuring the liquid level, said sensor unit being connected to the liquid space in the pump sump and being designed to measure the hydrostatic pressure which is created by the liquid level in the pump sump.

2. Measurement arrangement according to claim 1, characterized in that the sensor unit is designed to measure the pressure of liquids and gases, in particular air.

3. Measurement arrangement according to claim 1, characterized in that the sensor unit is arranged on the pump sump directly or by means of a coupling piece.

4. Measurement arrangement according to claim 1, characterized in that the sensor unit is arranged on the pump sump in such a way that liquid enters a measurement space in the sensor unit.

5. Measurement arrangement according to claim 1, characterized in that the sensor unit has a diaphragm which delimits a measurement space and which can be deformed by the hydrostatic pressure of the liquid.

6. Measurement arrangement according to claim 5, characterized in that a magnet, in particular a permanent magnet, is provided on that side of the diaphragm which is averted from the measurement space.

7. Measurement arrangement according to claim 6, characterized in that the sensor unit is designed to determine the filling level based on the distance of the magnet from a measurement electronics system.

8. Measurement arrangement according to claim 5, characterized in that an intermediate layer is provided beneath the diaphragm, the said intermediate layer delimiting a space beneath the diaphragm from the measurement electronics system.

9. Measurement arrangement according to claim 8, characterized in that the intermediate layer has at least two layers of an electrically insulating material.

10. Measurement arrangement according to claim 6, characterized in that a measurement electronics system which is situated opposite the magnet is provided with a sensor element which interacts with the magnet.

11. Measurement arrangement according to claim 10, characterized in that the sensor element has a magnetoresistive element, the electrical resistance of the said magnetoresistive element changing as a function of the position of the magnet.

12. Measurement arrangement according to claim 10, characterized in that the sensor element has at least one electrical resonant circuit, the resonant frequency of the said resonant circuit changing as a function of the position of the magnet.

13. Dishwasher comprising:
a measurement arrangement for determining the liquid level in a dishwasher, the measurement arrangement comprising:
a housing having a liquid pump which is connected, at the intake end, to a pump sump which is formed in the housing and comprises a liquid space, having a liquid inlet which is provided on the housing and by means of which liquid from a dishwashing space in the dishwasher flows into the pump sump, having a liquid outlet which is formed in the housing and is connected to the delivery end of the liquid pump, wherein a sensor unit is provided for measuring the liquid level, said sensor unit being connected to the liquid space in the pump sump and being designed to measure the hydrostatic pressure which is created by the liquid level in the pump sump.
